(19) United States
(12) Patent Application Publication
(10) Pub. No.: US 2026/0279331 A1
(43) Pub. Date: Sep. 17, 2026

(54) SPEECH TRANSFORMATION METHOD FOR DEFENSE AGAINST VOICE CLONING ATTACK

(71) Applicant: Foundation of Soongsil University-Industry Cooperation, Seoul (KR)

(72) Inventors: Dae Seon CHOI, Daejeon (KR); Seung Min KIM, Gimpo-si (KR)

(73) Assignee: Foundation of Soongsil University-Industry Cooperation, Seoul (KR)

(21) Appl. No.: 19/437,589

(22) Filed: Dec. 31, 2025

(30) Foreign Application Priority Data
Mar. 12, 2025 (KR) 10-2025-0032204

(51) Int. Cl. G10L 13/047

(52) U.S. Cl. CPC G10L 13/047

(57) ABSTRACT

An operation method of an electronic device for preventing synthetic voice attacks according to an embodiment of the present disclosure includes: extracting feature information of an original voice through an encoder module; converting the feature information into a first feature vector through at least one transformer module; generating a second feature vector by applying a perturbation to the first feature vector based on at least one other target voice different from the original voice; and generating a protected voice for the original voice based on the second feature vector through a decoder module.

### CROSS-REFERENCE TO RELATED APPLICATION(S)

This application claims the benefit under 35 USC 119(a) of Korean Patent Application No. 10-2025-0032204, filed with the Korean Intellectual Property Office on Mar. 12, 2025, the disclosure of which is incorporated herein by reference in its entirety

### TECHNICAL FIELD

The present disclosure relates to a speech transformation method for defense against synthetic voice attacks.

### BACKGROUND

With the rapid advancement of artificial intelligence (AI)-based voice synthesis technology, the potential for malicious uses such as voice phishing, voice fraud, and the spread of misinformation has been increasing. In particular, deep voice technology utilizing deep learning allows for precisely mimicking a specific speaker's voice by learning an existing recorded speech, which has emerged as a major social issue when exploited for fraud or criminal activities. Accordingly, various detection and defense technologies are being studied to distinguish synthesized voices from real speakers' voices.

Existing defense technologies include methods for detecting synthesized content or embedding watermarks into voice data for post-verification. However, these technologies focus on identifying fake voices only after they have already been generated, which limits their effectiveness in preventing immediate harm such as voice phishing. In addition, techniques that inject adversarial noise at the signal level to disrupt speech synthesis models have also been studied, but such modifications can be easily removed by a speech enhancement technology (noise removal), thereby reducing their substantial defensive effects. Due to these issues, the need for innovative defense technologies that can proactively block unauthorized voice synthesis has been increasing.

### Prior Art Documents

### Patent Documents

(Patent Document 1) Korean Laid-Open Patent No. 10-2024-0059350 (Speech Signal De-identification Method and Electronic Device Thereof.

### SUMMARY

The present disclosure aims to provide a novel defense technology for protecting voice data against AI-based deep voice synthesis attacks. Specifically, unlike conventional signal-level defense techniques, the present disclosure seeks to proactively prevent unauthorized voice synthesis by injecting adversarial perturbation into a high-dimensional embedding vector of a speech synthesis model.

Through this, voice phishing or malicious voice fraud attacks can be effectively blocked, and unauthorized imitation of a speaker's voice can be prevented.

The objects of the present disclosure are not limited to the above-mentioned objects, and other objects and advantages of the present disclosure that are not mentioned will be understood through the following description, and will be more clearly understood by the embodiments of the present disclosure. Moreover, it will be readily appreciated that the objects and advantages of the present disclosure may be realized by means and combinations thereof indicated in the claims.

An embodiment of the present disclosure provides an operation method of an electronic device for preventing synthetic voice attacks, the operation method including: extracting feature information of an original voice through an encoder module; converting the feature information into a first feature vector through at least one transformer module; generating a second feature vector by applying a perturbation to the first feature vector based on at least one other target voice different from the original voice; and generating a protected voice for the original voice based on the second feature vector through a decoder module.

A first learning process may be repeatedly performed, the first learning process including: obtaining a first loss value for feature information by inputting each of the protected speech and the target speech into an encoder of a speech synthesis model; reconstructing the second feature vector by applying a perturbation to the first feature vector based on the obtained first loss value; and reconstructing a protected voice for the original voice based on the reconstructed second feature vector through a decoder module.

The operation method may further include terminating the first learning process if the first loss value corresponding to the difference between the feature information of the protected voice and the feature information of the target voice, as identified by the encoder of the speech synthesis model, falls within a preset threshold range.

A second learning process may be repeatedly performed, the second learning process including: obtaining a second loss value corresponding to the difference in signal-to-noise ratio between the protected voice and the original voice, once the first learning process is terminated; reconstructing the second feature vector by applying a perturbation to the first feature vector based on the obtained first loss value; and reconstructing a protected voice for the original voice based on the reconstructed second feature vector through a decoder module.

The operation method may further include terminating the second learning process if the second loss value falls within the preset threshold range.

The transformer module may utilize a Coarse Transformer which helps maintain temporal patterns and structural consistency of the original voice, and a Fine Transformer which refines detailed acoustic information of the original voice.

The operation method may further include: obtaining a first loss value corresponding to the difference between the feature information of the protected voice and the target voice and a second loss value corresponding to the difference in signal-to-noise ratio between the protected voice and the original voice; and repeatedly performing both a first learning process and a second learning process, wherein, in the first learning process, if the first loss value does not fall within a threshold range, a perturbation adjusted to decrease the first loss value is applied to the first feature vector to generate a second feature vector, and in the second learning process, if the second loss value does not fall within a threshold range, a perturbation adjusted to decrease the second loss value is applied to the first feature vector to generate a second feature vector.

Another embodiment of the present disclosure provides an operation method of an electronic device for preventing synthetic voice attacks, the operation method including: converting an original voice into a first feature vector through an encoder module; generating a second feature vector by applying a perturbation to the first feature vector based on at least one target voice different from the original voice; generating a protected voice for the original voice based on the second feature vector through a decoder module; obtaining a first loss value corresponding to the difference between the feature information of the protected voice and the target voice; and repeatedly performing a first learning process including an operation of generating a second feature vector by applying a perturbation updated to decrease the first loss value to the first feature vector, if the first loss value does not fall within a threshold range, and an operation of generating the protected voice based on the second feature vector and terminating the first learning process, if the first loss value falls within the threshold range.

Another embodiment of the present disclosure provides an operation method of an electronic device for preventing synthetic voice attacks, the operation method including: converting an original voice into a first feature vector through an encoder module; generating a second feature vector by applying a perturbation to the first feature vector based on at least one target voice different from the original voice; generating a protected voice for the original voice based on the second feature vector through a decoder module; obtaining a second loss value corresponding to the difference in signal-to-noise ratio between the protected voice and the target voice; and repeatedly performing a second learning process including an operation of generating a second feature vector by applying a perturbation updated to decrease the second loss value to the first feature vector, if the second loss value does not fall within a threshold range, and an operation of generating the protected voice based on the second feature vector and terminating the second learning process, if the second loss value falls within the threshold range.

The present disclosure prevents a speech synthesis model from learning and imitating a specific speaker's voice, thereby reducing threats such as voice-based fraud and voice phishing.

In addition, unlike conventional approaches that inject perturbation at the signal level, the present disclosure utilizes an embedding space to inject perturbation, so that a defended voice can maintain the naturalness of the original speaker's voice.

### BRIEF DESCRIPTION OF THE DRAWINGS

FIG. 1 is a diagram illustrating a voice data processing method for preventing synthetic voice attacks, performed by an electronic device, according to an embodiment of the present disclosure.

FIG. 2 is a diagram illustrating components of an electronic device according to an embodiment of the present disclosure.

FIG. 3 is a flowchart illustrating the sequence of an operation method of an electronic device according to an embodiment of the present disclosure.

### DETAILED DESCRIPTION

The advantages and features of the present disclosure and methods for achieving them will become apparent by reference to the embodiments described in detail below together with the accompanying drawings. However, the present disclosure is not limited to the embodiments disclosed herein and may be implemented in various different forms. Rather, these embodiments are provided so that this disclosure will be thorough and complete, and will fully convey the scope of the disclosure to those skilled in the art. The present disclosure is defined only by the scope of the claims.

The terminology used in this specification is intended for describing embodiments and is not intended to limit the present disclosure. In this specification, the singular form includes the plural form unless otherwise specifically stated. The terms “comprises” and/or “comprising” as used in the specification do not exclude the presence or addition of one or more components other than those mentioned. Like reference numerals refer to like elements throughout the specification, and the term “and/or” include each and all combinations of the mentioned components. Although terms such as “first,” “second,” and the like may be used to describe various components, such components are not limited by these terms. These terms are merely used to distinguish one component from another. Accordingly, a first component mentioned below may also be a second component within the technical scope of the present disclosure.

Unless otherwise defined, all terms (including technical and scientific terms) used in this specification shall be understood to have the meanings commonly understood by those of ordinary skill in the art to which the present disclosure pertains. In addition, terms that are generally defined in dictionaries should not be interpreted in an idealized or overly broad sense unless explicitly and specifically defined herein.

The term “unit” or “module” used herein refers to a software element or a hardware element such as a field-programmable gate array (FPGA) or an application-specific integrated circuit (ASIC), and the “unit” or “module” performs a certain role. However, the “unit” or “module” is not limited to software or hardware. A “unit” or “module” may be embodied in a storage medium that can be addressed, or may be configured to reproduce one or more processors. Thus, by way of example, a “unit” or “module” may include components such as software components, object-oriented software components, class components, and task components, processes, functions, attributes, procedures, subroutines, segments of program code, drivers, firmware, microcode, circuits, data, databases, data structures, tables, arrays, and variables. The functions provided within the components and “units” or “modules” may be combined into a smaller number of components and “units” or “modules,” or may be further separated into additional components and “units” or “modules.”

Spatially relative terms such as “below,” “beneath,” “lower,” “above,” and “upper” may be used to describe the relationship between one component and other components as illustrated in the drawings. It will be understood that the spatially relative terms are intended to encompass different orientations of components in addition to the orientation depicted in the drawings during use or operation. For example, if a component shown in the drawings is inverted, a component described as being “below” or “beneath” another component may then be positioned “above” the other component. Accordingly, the exemplary term “below” or “beneath” can encompass the directions of both above and below or beneath. A component may also be oriented in other directions, and thus spatially relative terms should be interpreted accordingly.

Hereinafter, embodiments of the present disclosure will be described with reference to the accompanying drawings.

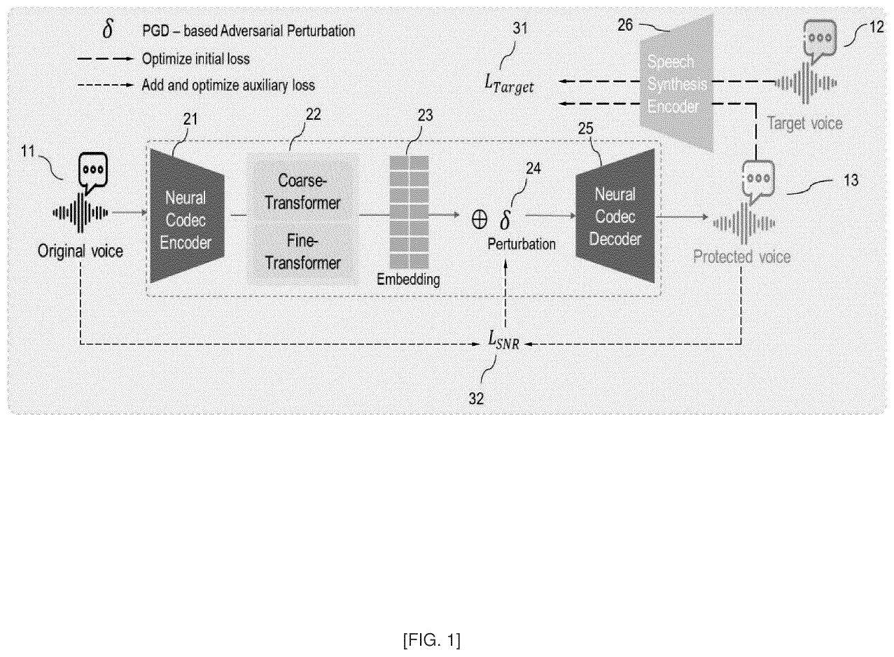

FIG. 1 is a diagram illustrating a voice data processing method for preventing synthetic voice attacks, performed by an electronic device, according to an embodiment of the present disclosure.

As shown in FIG. 1, the operation method performed by the electronic device according to an embodiment of the present disclosure may be carried out.

The electronic device may receive an original voice 11 as input and convert the received original voice into an embedding vector by utilizing an encoder module 21. The embedding vector may include key attributes such as the identity of the speaker of the original voice, the speaker's timbre, and phonological characteristics, thereby providing a rich and efficient representation required for subsequent processing. The embedding vector may then be processed through a transformer module 22. Specifically, the embedding vector may be processed through two main stages: a Coarse Transformer and a Fine Transformer.

The Coarse Transformer and the Fine Transformer are a technique for efficiently configuring a transformer-based model, which may be used to reduce computational load during voice data processing while preserving important information. This technique may be employed primarily in a coarse-to-fine processing approach, wherein the Coarse Transformer summarizes data into a compressed representation for rapid processing, and the Fine Transformer restores detailed features to generate more precise results.

Specifically, the Coarse Transformer focuses on maintaining overall temporal patterns and the consistency of speech structures so as to preserve the main characteristics of the speech, whereas the Fine Transformer refines detailed acoustic information to ensure that the reconstructed speech remains natural and perceptually accurate.

An adversarial perturbation 24 may then be applied to the embedding vector (first feature vector) processed through the transformer module 22 to generate a second feature vector.

In this case, the adversarial perturbation may be configured such that a protected voice resembles a target voice. The target voice is a reference voice that is set to protect the original voice, and serves as a standard voice that induces the protected voice to appear as if it originates from a speaker other than the original speaker.

When the second feature vector is generated, a decoding module 25 may convert the second feature vector into a speech form. The voice converted through the decoding module 25 may become a protected voice 13.

Furthermore, the protected voice 13 generated through the decoding module 25 may be reconstructed through a process of adjusting the value of the applied perturbation 24.

Specifically, the electronic device may obtain a first loss value 31 corresponding to the difference between feature information of the protected voice and feature information of the target voice by inputting each of the protected voice and the target voice into an encoder 26 of a speech synthesis model. If the first loss value 31 does not fall within a preset threshold range, the electronic device may perform an optimization process until the first loss value falls within the threshold range. In order to gradually reduce the distance (loss) between the feature vectors of the protected voice and the target voice, the first loss value may be set to gradually decrease. That is, the perturbation applied to the first feature vector may be reapplied such that the first loss value gradually decreases.

If the first loss value gradually decreases and falls within a threshold range in which the feature vectors of the target voice and the protected voice are recognized as being very close, the learning (first learning process) for decreasing the first loss value is terminated, and at that time, the protected voice may be output as final result data

Once the first learning process is terminated, a second learning process may be performed such that the difference (second loss value) in signal-to-noise ratio between the protected voice and the original voice falls within a preset threshold range. If the second loss value does not fall within the preset threshold range, the perturbation value may be repeatedly updated such that the second loss value decreases to a point within the threshold range. Accordingly, a second feature vector may be derived by applying the updated perturbation value, and a protected voice may be generated by converting the derived second feature vector. That is, the electronic device may repeatedly perform the second learning process, which includes an operation of modifying the perturbation value according to a loss function, an operation of deriving a second feature vector by applying the modified perturbation value, and an operation of generating a protected voice by converting the derived second feature vector through the decoding module.

If the second loss value is found to fall within the preset threshold range, the electronic device may terminate the second learning process.

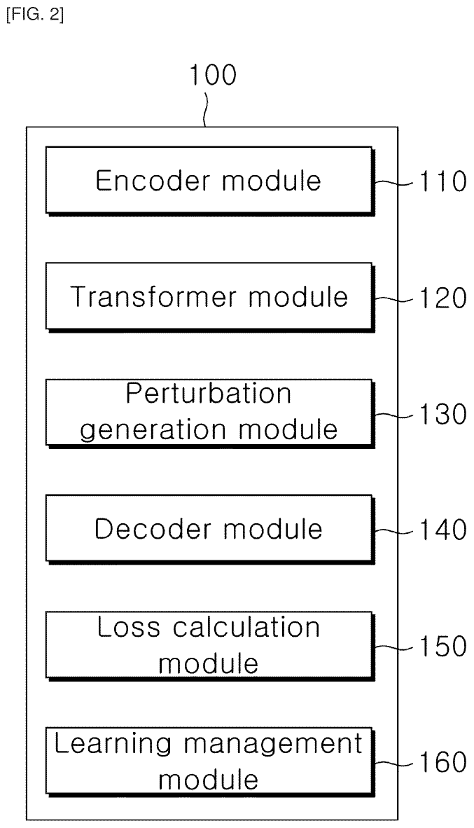

FIG. 2 is a diagram illustrating components of an electronic device according to an embodiment of the present disclosure.

Hereinafter, with reference to FIG. 2, the operations performed by components of the electronic device 100 will be described in detail.

The electronic device 100 may include an encoder module 110, a transformer module 120, a perturbation generation module 130, a decoder module 140, a loss calculation module 150, and a learning management module 160.

The encoder module 110 may perform an operation of extracting feature information from the original voice.

A Neural Codec Encoder may be used as the encoder module 110. The Neural Codec is a neural network-based codec technology that efficiently compresses and reconstructs audio signals. That is, the Neural Codec Encoder may refer to a neural network model responsible for encoding in the neural codec.

The encoder module 110 may perform a role of extracting important features from the signal of the original audio data. For example, the encoder module 110 may extract speaker characteristics, emotions, timbre, and pronunciation information included in the speech signal from the original audio data (original voice).

In various embodiments, the encoder module 110 may receive the original voice as input and convert it into an embedding vector (feature vector).

The transformer module 120 may perform an operation of taking in the feature information (feature vector) extracted by the encoder module 110 and structurally converting and refining it.

In this process, the transformer module 120 may receive the feature information extracted by the encoder module 110 as input and process it using the Coarse Transformer and the Fine Transformer to derive a first feature vector. The processing operation of the transformer module 120 may be performed to refine the feature vector so that it becomes suitable for a perturbation to be applied thereto.

The Coarse Transformer may perform a role of refining the structure of data while maintaining overall temporal patterns, and the Fine Transformer may perform a role of adjusting subtle acoustic elements of speech so as to maintain quality.

According to the data processing operation through the transformer module 120, when the first feature vector is obtained, the obtained first feature vector may be delivered to the perturbation generation module 130.

The perturbation generation module 130 may perform an operation of generating an adversarial perturbation and applying it to the first feature vector, thereby generating a second feature vector. According to an embodiment of the present disclosure, the perturbation generation module 130 may leverage a Perceptual Alternation Loss (PerC-AL) framework to derive an optimal second feature vector in order to achieve the objectives of maintaining speech quality and providing strong defense against synthesis attacks.

The perturbation generation module 130 may use a target-based loss function and a signal-to-noise ratio (SNR) loss function so that they operate in a complementary manner.

In this case, the target-based loss function, introduced in Antifake, may distort the speaker embedding of the speech synthesis model to ensure that the defended voice (protected voice) is not recognized as the original speaker. This loss function operates in the embedding space, and may induce the embedding vector of a modified speech signal to become closer to the embedding vector value of a predefined target voice through adversarial perturbation.

That is, the perturbation generation module 130 may perform first learning such that the target loss value corresponding to the difference between the feature information (feature vectors) of the target voice and the protected voice is decreased (such that the feature vector of the protected voice becomes similar to the feature vector of the target voice), and accordingly may generate a modified perturbation value.

In addition, when the learning management module 160 determines that the target loss value (first loss value) does not fall within a preset threshold range, the perturbation generation module 130 may repeatedly update the perturbation value to reconstruct the second feature vector. However, when the learning management module 160 determines that the first loss value falls within the preset threshold range, it may discontinue the operation of updating the perturbation value.

In addition to the target-based loss function, the perturbation generation module 130 may optimize the perturbation based on an SNR loss function. Since the first loss value falls within the preset threshold range, the perturbation generation module 130 may perform a second learning process to minimize the SNR loss value (the difference between the SNR of the protected voice and the SNR of the original voice). Furthermore, if the SNR loss value (second loss value) falls within a preset threshold range (or is below a threshold), the perturbation generation module 130 may terminate the second learning process.

The decoder module 140 may perform an operation of converting an optimized feature vector to generate a protected voice. Similarly to the encoder module, the decoder module 140 may correspond to a neural codec decoder which uses a neural codec.

The loss calculation module 150 may perform an operation of calculating the first loss value (which corresponds to the difference between the feature vector of the protected voice and the feature vector of the target voice) according to the present disclosure. To calculate the first loss value, the loss calculation module 150 may include an encoder of the speech synthesis model, receive the protected voice and the target voice as inputs, extract the feature vectors of the respective voices, and measure the distance (first loss value) between the two types of feature vectors.

At this time, the first loss value may be utilized as an indicator of how similar the feature vector of the protected voice, generated by injecting a perturbation into the original voice, has become to the feature vector of the target voice. A voice having features clearly distinct from those of the original voice may be adopted as the target voice. For example, if the original voice is a female speaker's voice, data corresponding to a male speaker's voice may be adopted as the target voice. In this manner, voice data clearly distinct from the original voice may be generally selected as the target voice, and since the protected voice is intended to defense against synthetic voice attacks by making the feature vector of the original voice look like the feature vector of the target voice, the feature vector of the protected voice aimed at having a value as similar as possible to those of the feature vector of the target voice.

That is, in order to increase the similarity between the protected voice and the target voice, the first loss value should be as small as possible, and to verify this, the loss calculation module 150 may calculate the first loss value.

The loss calculation module 150 may calculate the first loss value (distance between feature vectors) based, for example, on Euclidean distance. However, the present disclosure is not limited to this, and the loss calculation module 150 may derive the first loss value using a similarity calculation method other than the Euclidean distance, or may calculate the first loss value by combining the Euclidean distance with another similarity calculation method such as cosine similarity.

In addition, the loss calculation module 150 may calculate the signal-to-noise ratio (SNR) between the protected voice generated by applying perturbation and the original voice, and accordingly may calculate the difference (second loss value) between the SNR of the protected voice and the SNR of the original voice.

The second loss value may be calculated to measure how much the signal quality of the protected voice, generated by applying perturbation to the original voice, differs from the signal quality of the original voice. The second loss value may be measured to prevent the protected voice, generated by injecting a perturbation into the original voice, from being too much different from the original voice to be perceived by a listener. In order for the protected voice to maintain similarity with the original voice, the second loss value should also be as small as possible, and to verify this, the loss calculation module may calculate the second loss value.

The learning management module 160 may determine whether the first loss value and the second loss value, calculated by the loss calculation module 150, fall within a preset threshold range, and accordingly may determine whether to discontinue the learning.

The threshold range as used herein refers to a level at which the first loss value and the second loss value have sufficiently decreased so that the protected voice becomes similar to the target voice while the difference in audio quality from the original voice remains within an acceptable range. That is, if the first loss value and the second loss value fall within a threshold range, this may mean that the first loss value and the second loss value have gradually decreased to a set reference or lower.

In addition, the learning management module 160 may check whether the first loss value falls within a preset threshold range, and accordingly may determine whether to discontinue the first learning process, and when the first learning process is discontinued, may then check whether the second loss value falls within a preset threshold range. If the second loss value falls within the preset threshold range, the learning management module 160 may decide to discontinue the second learning process.

According to various embodiments, the learning management module 160 may provide support to simultaneously perform the first learning process and the second learning process.

Alternatively, even after the first learning process has been terminated upon finding that the first loss value falls within the threshold range, the learning management module 160 may continuously check whether the first loss value (target loss value) falls within the threshold range during the second learning process. If the learning management module 160 finds that the first loss value falls outside the threshold range during the second learning process, the learning management module 160 may temporarily stop the second learning process and allow the first learning process to be re-performed.

Alternatively, the learning management module 160 may set a preset threshold for each step, and if a loss value satisfies the threshold for each step, it may terminate the learning operation for the corresponding step and provide support to perform the first learning process and the second learning process alternately for each step. For example, the learning management module 160 may perform the second learning process of the first step after completion of the first learning process of the first step and perform the first learning process of the second step after completion of the second learning process of the first step. In this way, multiple steps may be set for each learning process, and when learning is completed for each step, the learning processes for the next step may be performed.

Once the learning management module 160 finds that both the first loss value and the second loss value have gradually decreased and fall within a preset threshold range, it may terminate both the first learning process and the second learning process.

Upon termination of both the first and second learning processes, the operation of applying a perturbation and extracting the second feature vector, performed by the perturbation generation module 130, may be discontinued, and the voice data obtained by converting the finally generated second feature vector may be finalized as protected voice.

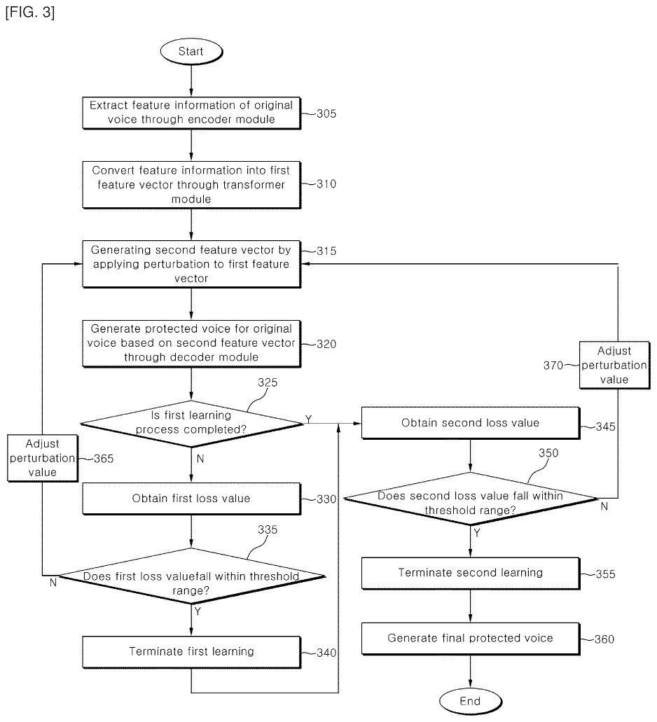

FIG. 3 is a flowchart illustrating the sequence of an operation method of an electronic device according to an embodiment of the present disclosure.

As shown in FIG. 3, the operation method of an electronic device according to the embodiment of the present disclosure may be summarized as follows: the operation method of the electronic device may include step 305 of extracting feature information of an original voice through an encoder module, step 310 of converting the feature information into a first feature vector through a transformer module, step 315 of generating a second feature vector by applying a perturbation to the first feature vector, and step 320 of generating a protected voice for the original voice based on the second feature vector through a decoder module.

In addition, the electronic device 100 undergoes step 325 of checking whether the first learning process is completed. If the first learning process is not yet completed, the electronic device 100 performs steps 330, 335, 365, 315, and 320 corresponding to the first learning process. Step 330 is a step in which the electronic device obtains a first loss value (a loss value corresponding to the distance between the feature vector of the target voice and the feature vector of the protected voice). Step 335 is a step of determining whether the first loss value falls within a threshold range. Step 365 is a step of adjusting the perturbation value when the first loss value is found not to fall within the threshold range in step 335.

The electronic device 100, after adjusting the perturbation value in step 365, returns to step 315. The electronic device 100 may re-perform the operation 315 of generating the second feature vector by applying the perturbation value adjusted in step 365 to the first feature vector. In this manner, the electronic device 100 may repeat the first learning process until the first loss value is found to fall within the threshold range.

Once the first loss value is found to fall within the threshold range, the electronic device 100 may perform step 340 of terminating the first learning process, and thereafter may perform the second learning process. The second learning process may include step 345 in which the electronic device 100 obtains a second loss value, step 350 in which it determines whether the obtained second loss value falls within a threshold range, step 370 in which the perturbation value is adjusted so that the second loss value decreases when the second loss value is found not to fall within the threshold range, step 315 in which the adjusted perturbation value is applied to generate a second feature vector, and step 320 in which the second feature vector is converted into voice data through a decoder to generate a protected voice.

The electronic device 100 may repeatedly perform an operation of adjusting the perturbation value so that the second loss value decreases until the second loss value is found to fall within the threshold range, and applying the adjusted perturbation value to the first feature vector to generate a second feature vector.

Once the second loss value is found to fall within the threshold range, the electronic device 100 may perform step 355 of identifying that the second learning process is completed, and accordingly may perform step 360 of selecting the protected voice derived at the time of completion as a final protected voice.

To sum up, the operation method of the electronic device for preventing synthetic voice attacks according to the present disclosure may include: a step of extracting feature information of an original voice through an encoder module; a step of converting the feature information into a first feature vector through at least one transformer module; a step of generating a second feature vector by applying a perturbation to the first feature vector based on at least one target voice different from the original voice; and a step of generating a protected voice for the original voice based on the second feature vector through a decoder module.

In addition, the operation method of the electronic device may repeatedly perform a first learning process including: a step of obtaining a first loss value for the feature information by inputting each of the protected voice and the target voice into an encoder of a speech synthesis model; a step of reconstructing the second feature vector by applying a perturbation to the first feature vector based on the obtained first loss value; and a step of reconstructing a protected voice for the original voice based on the reconstructed second feature vector through a decoder module.

In addition, the operation method of the electronic device may include a step of terminating the first learning process if the first loss value corresponding to the difference between the feature information of the protected voice and the feature information of the target voice, as identified by the encoder of the speech synthesis model, falls within a preset threshold range.

In addition, the operation method of the electronic device may repeatedly perform a second learning process including: a step of obtaining a second loss value corresponding to the difference in signal-to-noise ratio between the protected voice and the original voice, once the first learning process is terminated; a step of reconstructing the second feature vector by applying a perturbation to the first feature vector based on the obtained second loss value; and a step of reconstructing a protected voice for the original voice based on the reconstructed second feature vector through a decoder module.

In addition, the operation method of the electronic device may include a step of terminating the second learning process if the second loss value falls within a preset threshold range.

Furthermore, the transformer module may operate by utilizing the Coarse Transformer, which helps maintain temporal patterns and structural consistency of the original voice, and the Fine Transformer, which refines detailed acoustic information of the original voice.

In addition, the operation method of the electronic device according to the present disclosure may further include a step of obtaining a first loss value corresponding to the difference between the feature information of the protected voice and the target voice and a second loss value corresponding to the difference in signal-to-noise ratio between the protected voice and the original voice, and a step of repeatedly performing both a first learning process and a second learning process, wherein, in the first learning process, if the first loss value does not fall within a threshold range, a perturbation adjusted to decrease the first loss value is applied to the first feature vector to generate a second feature vector, and in the second learning process, if the second loss value does not fall within the threshold range, a perturbation adjusted to decrease the second loss value is applied to the first feature vector to generate a second feature vector.

Alternatively, according to various embodiments, in the operation method of the electronic device, the first learning process and the second learning process may be performed alternately.

In addition, the operation method of the electronic device for preventing synthetic voice attacks may include: a step of converting an original voice into a first feature vector through an encoder module; a step of generating a second feature vector by applying a perturbation to the first feature vector based on at least one target voice different from the original voice; a step of generating a protected voice for the original voice based on the second feature vector through a decoder module; a step of obtaining a first loss value corresponding to the difference between the feature information of the protected voice and the target voice; and a step of repeatedly performing a first learning process including an operation of generating a second feature vector by applying a perturbation updated to decrease the first loss value to the first feature vector, if the first loss value does not fall within a threshold range, and an operation of generating the protected voice based on the second feature vector and terminating the first learning process, if the first loss value falls within the threshold range.

In addition, the operation method of the electronic device for preventing synthetic voice attacks may include: a step of converting an original voice into a first feature vector through an encoder module; a step of generating a second feature vector by applying a perturbation to the first feature vector based on at least one target voice different from the original voice; a step of generating a protected voice for the original voice based on the second feature vector through a decoder module; a step of obtaining a second loss value corresponding to the difference in signal-to-noise ratio between the protected voice and the target voice; and a step of repeatedly performing a second learning process including an operation of generating a second feature vector by applying a perturbation updated to decrease the second loss value to the first feature vector, if the second loss value does not fall within a threshold range, and an operation of generating the protected voice based on the second feature vector and terminating the second learning process, if the second loss value falls within the threshold range.

The electronic device 100 according to an embodiment of the present disclosure may include a processor, a memory, a communication unit, etc.

The memory may store various programs and data necessary for the operation of the electronic device. The memory may be implemented as non-volatile memory, volatile memory, flash memory, a hard disk drive (HDD), or a solid state drive (SSD).

The communication unit may perform communication with external devices. In particular, the communication unit may include various communication chips such as a Wi-Fi chip, a Bluetooth chip, a wireless communication chip, an NFC chip, and a low-energy Bluetooth (BLE) chip. In this case, the Wi-Fi chip, the Bluetooth chip, and the NFC chip may perform communication according to LAN, Wi-Fi, Bluetooth, and NFC methods, respectively. When using a Wi-Fi chip or a Bluetooth chip, various connection information such as SSID and session keys may first be transmitted and received, and this connection information may be used to establish a communication connection and then transmit and receive various information. The wireless communication chip refers to a chip that performs communication according to various communication standards such as IEEE, ZigBee, 3G (3rd Generation), 3GPP (3rd Generation Partnership Project), and LTE (Long Term Evolution).

The processor may control the overall operation of a user device by using various programs stored in the memory. The processor may be configured with RAM, ROM, a graphics processing unit, a main CPU, first to n-th interfaces, and a bus. In this case, the RAM, the ROM, the graphics processing unit, the main CPU, and the first to n-th interfaces may be interconnected via the bus.

The RAM stores an operating system (O/S) and application programs. Specifically, when the electronic device is booted, the O/S is stored in the RAM, and various application data selected by the user may be stored in the RAM.

The ROM stores an instruction set or the like for system booting. When a turn-on command is input and power is supplied, the main CPU copies the O/S stored in the memory 200 into the RAM according to the instructions stored in the ROM, and executes the O/S to boot the system. Once booting is completed, the main CPU copies various application programs stored in the memory into the RAM and executes the application programs copied into the RAM to perform various operations.

The main CPU may access the memory and perform operations including booting and execution by using the OS stored in the memory. In addition, the main CPU may perform various operations by using various programs, content, and data stored in the memory.

The first to n-th interfaces may be connected to the above-described components, and one of the first to n-th interfaces may be a network interface that connects to external devices through a network.

Meanwhile, furthermore, the processor may control an artificial intelligence model. In this case, the control unit may include a dedicated graphics processor (e.g., GPU) for controlling the artificial intelligence model.

The processor may include one or more cores (not shown), a graphics processing unit (not shown), and/or a communication pathway (e.g., a bus) for transmitting and receiving signals with other components.

In one embodiment, the processor may perform the method described in connection with the present disclosure by executing one or more instructions stored in the memory.

Meanwhile, the processor may further include RAM (Random Access Memory, not shown) and ROM (Read-Only Memory, not shown) for temporarily and/or permanently storing signals (or data) processed inside the processor. In addition, the processor 130 may be implemented in the form of a system on chip (SoC) including at least one of a graphics processing unit, RAM, and ROM.

The memory may store programs (one or more instructions) for processing and controlling the processor. The programs stored in the storage unit may be divided into a plurality of modules according to their functions.

The steps of a method or algorithm described in connection with an embodiment of the present disclosure may be implemented directly in hardware, implemented as software modules executed by hardware, or implemented by a combination thereof. The software modules may reside in RAM (Random Access Memory), ROM (Read Only Memory), EPROM (Erasable Programmable ROM), EEPROM (Electrically Erasable Programmable ROM), flash memory, a hard disk, a removable disk, a CD-ROM, or any form of computer-readable recording medium well known in the art to which the present disclosure pertains.

The components of the present disclosure may be implemented as programs (or applications) and stored in a medium to be executed in conjunction with computer hardware. The components of the present disclosure may be executed by software programming or software elements. Similarly, embodiments may be implemented in programming or scripting languages such as C, C++, Java, or assembler, including various algorithms implemented as combinations of data structures, processes, routines, or other programming constructs. Functional aspects may be implemented as algorithms executed on one or more processors.

Although the present disclosure has been described in detail with reference to the foregoing examples, it will be understood by those skilled in the art that modifications, changes, and variations may be made to the examples without departing from the scope of the present disclosure. In short, it should be noted that, in order to achieve the intended effects of the present disclosure, it is not necessary to separately include all functional blocks illustrated in the drawings or to follow all sequences exactly as shown. Even without doing so, the disclosure may still fall within the technical scope defined by the claims.

What is claimed is:

1. An operation method of an electronic device for preventing synthetic voice attacks, the operation method comprising:
extracting feature information of an original voice through an encoder module;
converting the feature information into a first feature vector through at least one transformer module;
generating a second feature vector by applying a perturbation to the first feature vector based on at least one other target voice different from the original voice; and
generating a protected voice for the original voice based on the second feature vector through a decoder module.

2. The operation method of claim 1, wherein a first learning process is repeatedly performed, the first learning process including:
obtaining a first loss value for feature information by inputting each of the protected speech and the target speech into an encoder of a speech synthesis model;
reconstructing the second feature vector by applying a perturbation to the first feature vector based on the obtained first loss value; and
reconstructing a protected voice for the original voice based on the reconstructed second feature vector through a decoder module.

3. The operation method of claim 2, further comprising terminating the first learning process if the first loss value corresponding to the difference between the feature information of the protected voice and the feature information of the target voice, as identified by the encoder of the speech synthesis model, falls within a preset threshold range.

4. The operation method of claim 3, wherein a second learning process is repeatedly performed, the second learning process including:
obtaining a second loss value corresponding to the difference in signal-to-noise ratio between the protected voice and the original voice, once the first learning process is terminated;
reconstructing the second feature vector by applying a perturbation to the first feature vector based on the obtained first loss value; and
reconstructing a protected voice for the original voice based on the reconstructed second feature vector through a decoder module.

5. The operation method of claim 4, further comprising terminating the second learning process if the second loss value falls within the preset threshold range.

6. The operation method of claim 1, wherein the transformer module utilizes a Coarse Transformer which helps maintain temporal patterns and structural consistency of the original voice, and a Fine Transformer which refines detailed acoustic information of the original voice.

7. The operation method of claim 1, further comprising:
obtaining a first loss value corresponding to the difference between the feature information of the protected voice and the target voice and a second loss value corresponding to the difference in signal-to-noise ratio between the protected voice and the original voice; and
repeatedly performing both a first learning process and a second learning process,
wherein, in the first learning process, if the first loss value does not fall within a threshold range, a perturbation adjusted to decrease the first loss value is applied to the first feature vector to generate a second feature vector, and in the second learning process, if the second loss value does not fall within a threshold range, a perturbation adjusted to decrease the second loss value is applied to the first feature vector to generate a second feature vector.

8. An operation method of an electronic device for preventing synthetic voice attacks, the operation method comprising:
converting an original voice into a first feature vector through an encoder module;
generating a second feature vector by applying a perturbation to the first feature vector based on at least one target voice different from the original voice;
generating a protected voice for the original voice based on the second feature vector through a decoder module;
obtaining a first loss value corresponding to the difference between the feature information of the protected voice and the target voice; and
repeatedly performing a first learning process including an operation of generating a second feature vector by applying a perturbation adjusted to decrease the first loss value to the first feature vector, if the first loss value does not fall within a threshold range, and an operation of generating the protected voice based on the second feature vector and terminating the first learning process, if the first loss value falls within the threshold range.

9. An operation method of an electronic device for preventing synthetic voice attacks, the operation method comprising:
converting an original voice into a first feature vector through an encoder module;
generating a second feature vector by applying a perturbation to the first feature vector based on at least one target voice different from the original voice;
generating a protected voice for the original voice based on the second feature vector through a decoder module;
obtaining a second loss value corresponding to the difference in signal-to-noise ratio between the protected voice and the target voice; and
repeatedly performing a second learning process including an operation of generating a second feature vector by applying a perturbation adjusted to decrease the second loss value to the first feature vector, if the second loss value does not fall within a threshold range, and an operation of generating the protected voice based on the second feature vector and terminating the second learning process, if the second loss value falls within the threshold range.

10. A computer program stored in a computer-readable recording medium, which, when executed by a processor of the electronic device, causes the electronic device to perform the operation method of claim 1.
